(19) United States
(12) Patent Application Publication
(10) Pub. No.: US 2019/0392607 A1
(43) Pub. Date: Dec. 26, 2019

(54) IMAGE PROCESSING APPARATUS, SYSTEM, IMAGE PROCESSING METHOD, ARTICLE MANUFACTURING METHOD, AND NON-TRANSITORY COMPUTER-READABLE STORAGE MEDIUM

(71) Applicant: CANON KABUSHIKI KAISHA, Tokyo (JP)

(72) Inventor: Takamasa Sasaki, Utsunomiya-shi (JP)

(21) Appl. No.: 16/558,662

(22) Filed: Sep. 3, 2019

Related U.S. Application Data
(63) Continuation of application No. PCT/JP2018/009481, filed on Mar. 12, 2018.

(30) Foreign Application Priority Data
Mar. 13, 2017 (JP) 2017-047488

(51) Int. Cl. G06T 7/70; G06T 7/521; G06T 7/55; G06T 5/00; G06T 5/50; G06T 1/00; B25J 9/16

(52) U.S. Cl. CPC G06T 7/70; G06T 7/521; G06T 7/55; G06T 2207/20192; G06T 5/50; G06T 1/0014; B25J 9/1697; G06T 5/006

(57) ABSTRACT

A first image obtained by capturing an image of an object on which pattern light is projected and a second image obtained by capturing an image of the object on which light not containing the pattern light is projected are acquired. A first distance image having a distance value for each pixel is generated based on the first image and distortion of the first image is corrected based on the distance value of the first distance image. A second distance image having a distance value for each pixel is generated based on the first image obtained after correcting distortion of the first image. Distortion of an edge image having edge information of the object in the second image is corrected by using the distance value of a corresponding pixel in the first distance image or the second distance image for each pixel of the edge image.

### CROSS-REFERENCE TO RELATED APPLICATIONS

This application is a Continuation of International Patent Application No. PCT/JP2018/009481, filed Mar. 12, 2018, which claims the benefit of Japanese Patent Application No. 2017-047488, filed Mar. 13, 2017, both of which are hereby incorporated by reference herein in their entirety.

### BACKGROUND OF THE INVENTION

### Field of the Invention

The present invention relates to a technique for obtaining the three-dimensional position and posture of an object.

### Background Art

There is available a technique for measuring the three-dimensional position and posture of an object by fitting distance point group data and edge point group data obtained from a captured image with a CAD model. In particular, according to an arrangement in which image capturing for acquiring distance data and image capturing for acquiring edge data are simultaneously performed using two image capturing elements, the measurement can be performed within a shorter period of time than a case in which image capturing for acquiring distance data and image capturing for acquiring edge data are performed using one image capturing element. This arrangement can be applied to the measurement during movement and the measurement of a moving object.

The correspondence relationship between the three-dimensional position of an object and the position of each pixel in a captured image is generally expressed by a camera model using a parameter such as a focal length. This parameter is called an internal parameter and its value is handled to be uniquely determined by an optical system in many cases. However, in practice, the value of this parameter changes in accordance with a distance to the object, that is, the position in the depth direction with respect to the image capturing element in accordance with the distortion of an image capturing optical system. For this reason, if a single parameter is used regardless of the position in the depth direction, the above correspondence relationship diverges from the actual optical system, resulting in a measurement error. The following technique is disclosed as a technique for reducing this measurement error.

According to the technique of PTL 1, temporary distance data is generated from a captured image using a temporary parameter. Position information in the depth direction which corresponds to each pixel in the captured image is obtained from the generated distance data. Final distance data is generated based on the position information in the depth direction using a parameter for each depth position prepared in advance.

According to the technique of PTL 2, the direction of a beam entering each pixel of an image capturing element is measured in advance. By using this measurement value, the above correspondence relationship is calculated by beam tracing in place of a camera model.

### CITATION LIST

### Patent Literature

PTL 1: Japanese Patent Laid-Open No. 2008-170280

PTL 2: Japanese Patent No. 4077755

However, the technique of PTL 1 cannot be applied to edge data which cannot obtain position information in a depth direction. The technique of PTL 2 requires the calculation of the correspondence relationship between the three-dimensional position and the position of each pixel of the captured image using the beam tracing of high calculation cost, thus disabling high-speed processing. That is, according to the problem in the related arts, high-speed, high-accuracy three-dimensional position and posture measurement of the object using the distance data and the edge data obtained from the captured image cannot be made.

The present invention has been made in consideration of the above problem and provides a technique for measuring the three-dimensional position and posture of an object at high speed and high accuracy by using the distance image and the edge image of the object.

### SUMMARY OF INVENTION

According to an aspect of the present invention, there is provided an image processing apparatus comprising an acquisition unit configured to acquire a first image obtained by capturing an image of an object on which pattern light is projected and a second image obtained by capturing an image of the object on which light not containing the pattern light is projected, a first correction unit configured to generate a first distance image having a distance value for each pixel based on the first image and correct distortion of the first image based on the distance value of the first distance image, a generation unit configured to generate a second distance image having a distance value for each pixel based on the first image obtained after correcting distortion of the first image by the first correction unit, and a second correction unit configured to correct distortion of an edge image having edge information of the object in the second image by using the distance value of a corresponding pixel in the first distance image or the second distance image for each pixel of the edge image.

Further features of the present invention will become apparent from the following description of exemplary embodiments with reference to the attached drawings.

### BRIEF DESCRIPTION OF DRAWINGS

FIG. 1 is a block diagram showing an example of the arrangement of a system.

FIG. 2 is a view showing an example of the arrangement of an image capturing unit 103.

FIG. 3 is a view showing an example of the arrangement of a multiline pattern 300.

FIG. 4 is a flowchart of a method of acquiring calibration data 125.

FIG. 5 is a flowchart showing processing in step S1002 in detail.

FIG. 6 is a flowchart showing processing in step S1003 in detail.

FIG. 7 is a view showing an example of a calibration board.

FIG. 8 is a block diagram showing an example of the hardware arrangement of a computer apparatus.

FIG. 9 is a view showing an example of the arrangement of table data of calibration data for each Z position.

FIG. 10 is a flowchart of processing performed by an image processing apparatus 121.

FIG. 11 is a view showing a control system including a measurement apparatus and a robot arm.

### DESCRIPTION OF EMBODIMENTS

Embodiments of the present invention will be described with reference to the accompanying drawings. Note that the embodiments to be described below are examples of detailed implementation of the present invention or detailed examples of the arrangement described in the appended claims.

### First Embodiment

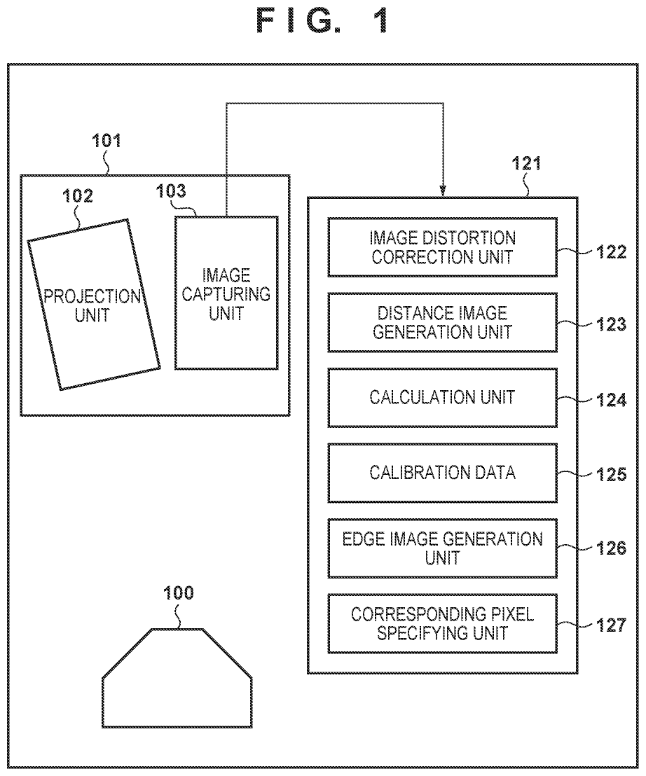

First, an example of the arrangement of a system according to this embodiment will be described using the block diagram of FIG. 1. The system according to this embodiment performs measurement (three-dimensional measurement) for the three-dimensional shape and three-dimensional position and posture of an object 100. As shown in FIG. 1, this system includes a three-dimensional scanner 101 and an image processing apparatus 121.

First, the three-dimensional scanner 101 will be described below. The three-dimensional scanner 101 includes a projection unit 102 for projecting pattern light on the object 100 and an image capturing unit 103 for capturing the image of the object 100.

For example, a multiline pattern 300 shown in FIG. 3 is used as pattern light (projection pattern) to be projected from the projection unit 102. Dots 302 are arranged in each line 301 of the multiline pattern 300 at a random interval as codes for identifying each line 301. If a captured image of the object on which the multiline pattern 300 is projected is obtained, the ordinal number of the line observed on the object in the projection pattern can be identified using, as a clue, the line and dot positions observed on the captured image. Since an arbitrary point on each line can undergo triangulation in accordance with a light-section method, three-dimensional positions (three-dimensional coordinates) of a plurality of lines can be measured by single image capturing. Note that a code for identifying each line of the multiline is not limited to random dots. For example, the thickness of each line may be changed, and each line may be identified based on the thickness of each line. The projection pattern is not limited to the multiline pattern. If a projection pattern can be associated with pattern light projected onto an object on a captured image, and a three-dimensional position can be measured from the image captured by single image capturing, any pattern may be employed.

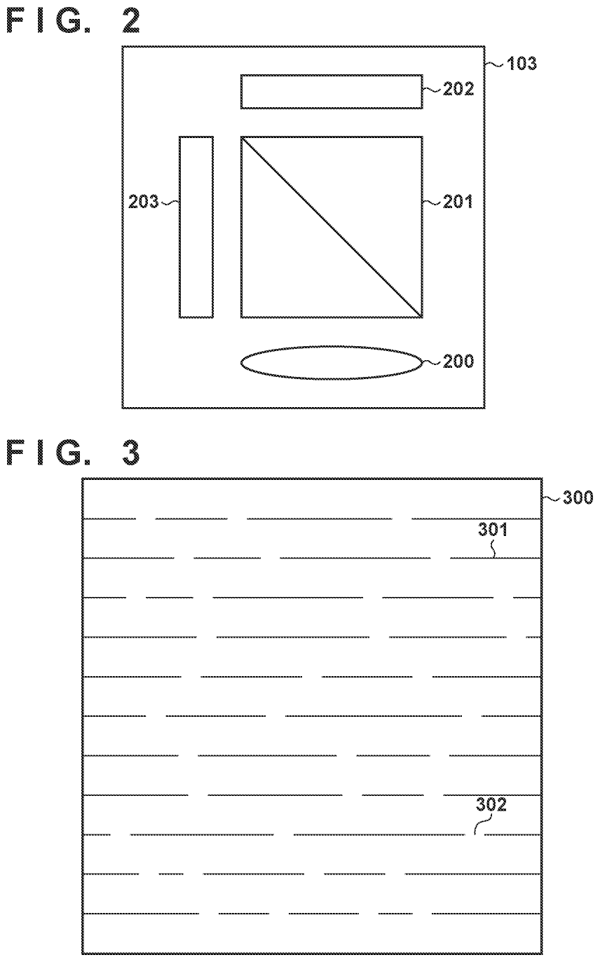

The image capturing unit 103 captures the image of the object 100 on which the projection pattern from the projection unit 102 is projected, thereby acquiring a captured image (the first captured image) including the projection pattern and a captured image (the second captured image) without including the projection pattern. An example of the arrangement of the image capturing unit 103 will be described with reference to FIG. 2.

External light enters a spectroscopic prism 201 via a lens 200. The spectroscopic prism 201 is used to spatially separate light (projection pattern light) of the projection pattern projected from the projection unit 102 and reflected by the object 100 and light (uniform illumination light) emitted from a uniform illumination (not shown) and reflected by the object 100. The wavelength of the projection pattern light is different from the wavelength of the uniform illumination light. The projection pattern light out of light entering the spectroscopic prism 201 passes through the spectroscopic prism 201 and enters an image capturing element 202. The uniform illumination light is reflected by the spectroscopic prism 201 and enters an image capturing element 203. Accordingly, the image capturing element 202 and the image capturing element 203 can almost simultaneously capture the first and second captured images having a small parallax.

The image capturing element 202 and the image capturing element 203 are formed from various kinds of photoelectric conversion elements such as CMOS sensors or CCD sensors. Note that analog signals photoelectrically converted by the image capturing elements 202 and 203 are sampled and quantized by a control unit (not shown) in the image capturing unit 103 and converted into digital image signals. In addition, this control unit generates an image (a captured image) in which each pixel has a luminance tone value (a density value or pixel value) from the digital image signals and sends the generated image to the memory in the image capturing unit 103 and/or the image processing apparatus 121 as needed.

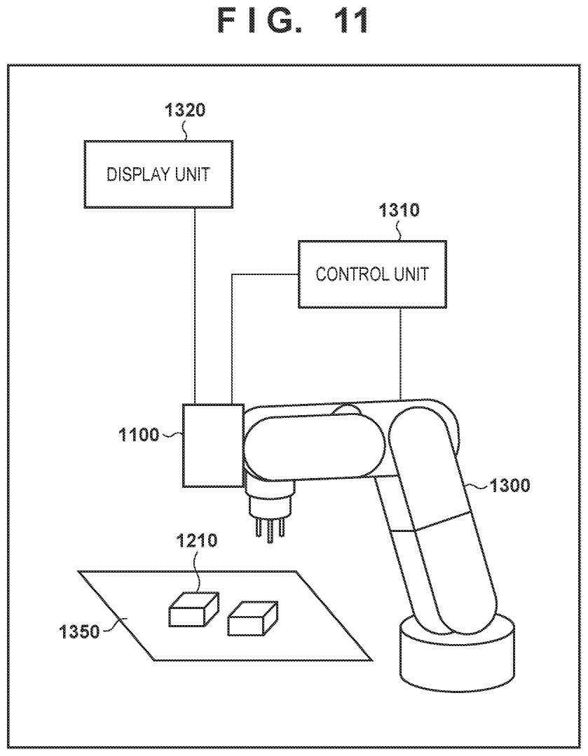

Next, the image processing apparatus 121 will be described below. Processing executed by the image processing apparatus 121 to obtain the three-dimensional position and posture of the object 100 based on the first and second captured images acquired from the three-dimensional scanner 101 will be described in accordance with the flowchart in FIG. 10. Note that the first and second captured images may be directly acquired from the three-dimensional scanner 101 or may be acquired as data once stored in the memory of the image processing apparatus 121 or an external memory and then read out.

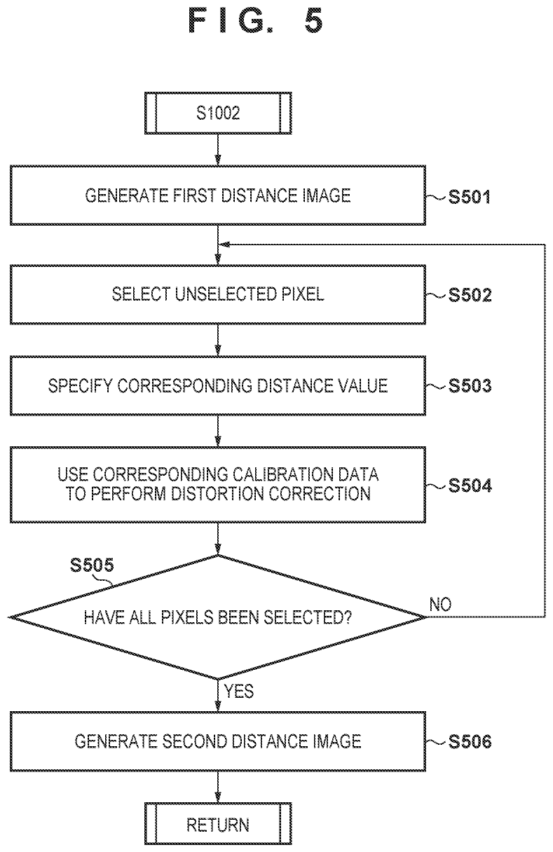

In step S1002, the image processing apparatus 121 performs distortion correction processing for the distance image based on the first captured image. Details of the processing in step S1002 will be described in accordance with the flowchart in FIG. 5.

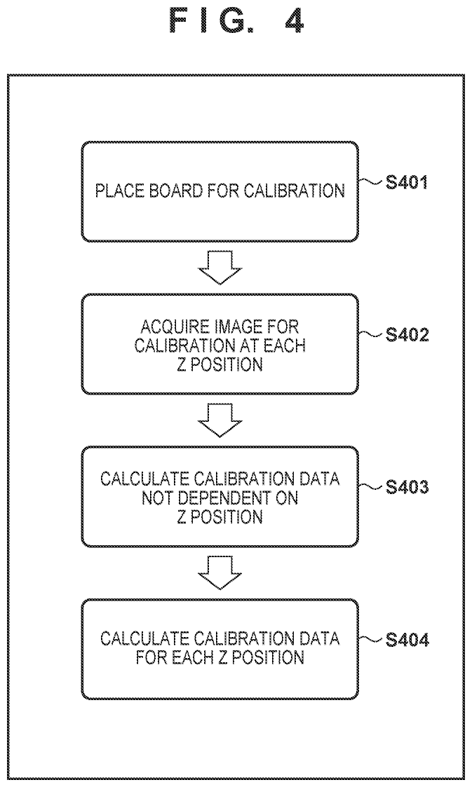

In step S501, a distance image generation unit 123 performs distortion correction processing for the first captured image using calibration data 125 as a correction parameter obtained in advance and generates a distance image (the first distance image) based on the principle of triangulation from the first captured image having undergone distortion correction processing. In this case, a method of acquiring the calibration data 125 will be described in accordance with the flowchart of FIG. 4. The calibration data 125 includes calibration data depending on the distance value (a Z position) and calibration data independent of the Z position.

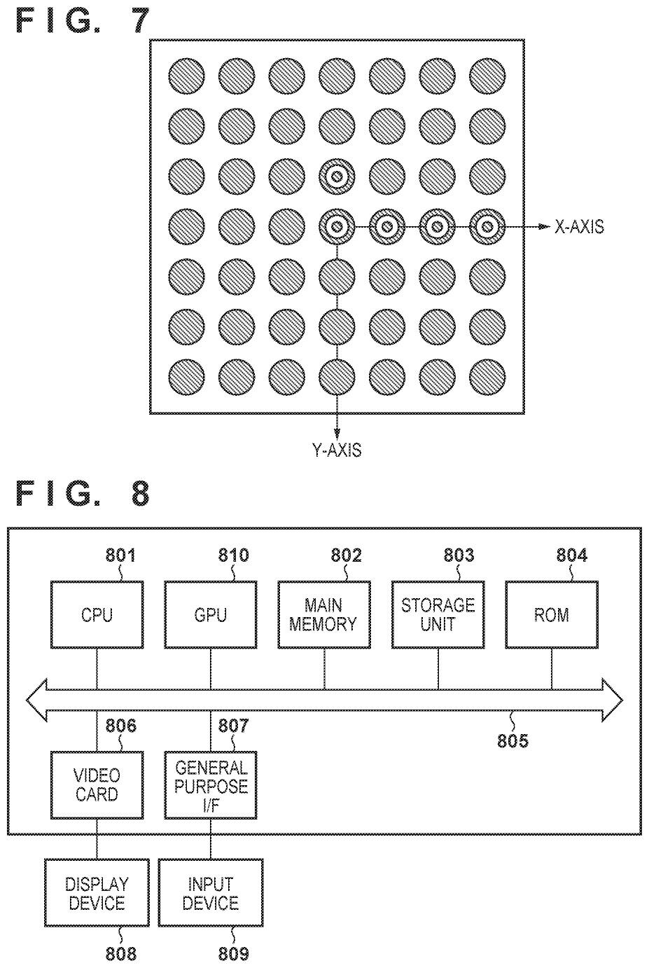

In step S401, the calibration board is placed on a uniaxial moving stage serving as a stage movable in a uniaxial direction. Assume that the moving direction of the uniaxial moving stage is defined as the Z-axis, and the X- and Y-axes are set within the calibration board. An example of the calibration board is shown in FIG. 7. A flat board on which indices such as circular patterns are printed two-dimensionally at a predetermined interval is used as the calibration board. In order to specify the X- and Y-axes on the calibration board, for example, as shown in FIG. 7, a plurality of double circle patterns are arranged in a circular pattern group, a direction along which many double circle patterns are arranged is defined as the X-axis, and a direction perpendicular to this is defined as the Y-axis. In order to accurately calculate the calibration data, the interval of the indices such as circular patterns is measured by a three-dimensional measuring machine. Although the index is given as a circular pattern, any other shape may be used if the position of an index on an image can be detected by image processing using a captured image.

In step S402, while the uniaxial moving stage is driven and moved within a measurement range on the Z-axis, the uniaxial moving stage (the calibration board) is captured a plurality of times. Accordingly, the captured images (the calibration images) of the calibration board at the plurality of positions (the Z positions) on the Z-axis are obtained. Assume that the image capturing device for capturing the uniaxial moving stage is fixed so as to oppose, for example, the calibration board. The X- and Y-coordinates of each index on the calibration board are known in advance, and the Z position of the captured image acquisition position can be determined using the moving interval of the uniaxial moving stage as the reference.

The processes in steps S401 and S402 are performed in a state in which the projection pattern is projected onto the calibration board and a state in which the projection pattern is not projected onto the calibration board. In the following description, the calibration image captured in the state in which the projection pattern is projected onto the calibration board is referred to as the first calibration image. The calibration image captured in the state in which the projection pattern is not projected onto the calibration board is referred to as the second calibration image. In addition, if an explanation is made commonly for the first calibration image and the second calibration image, they are referred to simply as the calibration images without distinguishing them.

The process in each of steps S401 and S402 is an example of a process for acquiring calibration images at a plurality of depths (Z positions) different from each other from the image capturing position. The method of acquiring the calibration images is not limited to a specific acquisition method if the calibration images at the plurality of depths (Z positions) different from each other from the image capturing position can be acquired. In this embodiment, the plurality of such calibration images are obtained by each of the image capturing element 202 and the image capturing element 203.

Next, in step S403, calibration data independent of the Z position is calculated from the first and second calibration images acquired in the processes of steps S401 and S402. The calibration data independent of the Z position are the internal and external parameters in a pin hole camera model (equations (1) to (8)) of each of the projection unit 102 and the image capturing unit 103. The internal parameters include focal lengths fx and fy, image centers cx and cy, and distortion coefficients k1, k2, k3, p1, and p2. The external parameters include posture R and position T.

$$\begin{matrix}[ \begin{matrix}x \\ y \\ z\end{matrix} ] = R [ \begin{matrix}X \\ Y \\ Z\end{matrix} ] + T & ( 1 ) \\ {x}^{′} = \frac{x}{z} & ( 2 ) \\ {y}^{′} = \frac{y}{z} & ( 3 ) \\ {x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′ 2} ) & ( 4 ) \\ {y}^{″} = {y}^{′} ( 1 + {k}_{1} {r}^{2} + {k}_{2} {r}^{4} + {k}_{3} {r}^{6} ) + 2 {p}_{2} {x}^{′} {y}^{′} + {p}_{1} ( {r}^{2} + 2 {y}^{′ 2} ) & ( 5 ) \\ where & \\ {r}^{2} = {x}^{′ 2} + {y}^{′ 2} & ( 6 ) \\ u = {f}_{x} * {x}^{″} + {c}_{x} & ( 7 ) \\ v = {f}_{y} * {y}^{″} + {c}_{y} & ( 8 )\end{matrix}$$

In this case, (X, Y, Z) represents three-dimensional coordinates of an index on the calibration board in a stage coordinate system (a coordinate system using the uniaxial moving stage as the reference). (u, v) represents two-dimensional coordinates of a point (an index on the calibration board and a dot in the projection pattern) projected on the image capturing element surface. Note that the distortion coefficients are not limited to the above coefficients k1, k2, k3, p1, and p2. Equations (4) and (5) may be extended so as to include high-order terms.

Since the image capturing unit 103 includes the two image capturing elements 202 and 203, the set of internal and external parameters described above is calculated for each of the image capturing elements 202 and 203. More specifically, two-dimensional coordinates (u, v) of each index on an image are calculated from the second calibration image by image processing, and the two-dimensional coordinates (u, v) are associated with the corresponding three-dimensional coordinates (X, Y, Z). In addition, the two-dimensional coordinates (u, v) of each dot on an image are calculated from the first calibration image by image processing, and the two-dimensional coordinates (u, v) are associated with the corresponding three-dimensional coordinates (X, Y, Z). Based on the above association results, the internal parameters of the projection unit 102 and the image capturing unit 103 (the image capturing element 202 and the image capturing element 203) and the external parameters between the projection unit 102 and the image capturing unit 103, between the projection unit 102 and the stage, and between the image capturing unit 103 and the stage are calculated. The internal parameters and the external parameters can be calculated using a known technique such as the bundle adjustment method.

Next, in step S404, calibration data for each Z position is calculated. If the calibration board is captured at 10 positions such as Z positions=Z1, Z2, . . . , Z10, 30 (=10× three internal parameters of the projection unit 102, the image capturing element 202, and the image capturing element 203) internal parameters are calculated. The internal parameters for each Z position can be obtained by using the following parameters.
The result of association between the two-dimensional coordinates (u, v) of each dot in the first calibration image for each Z position on the first calibration image and the corresponding three-dimensional coordinates (X, Y, Z).
The result of association between the two-dimensional coordinates (u, v) of each index in the second calibration image for each Z position on the second calibration image and the corresponding three-dimensional coordinates (X, Y, Z).
Calibration data independent of the Z position.

The internal parameters and the external parameters are calculated by a method such as a nonlinear optimization method so as to fit the result of association with the pin hole camera model. The relationship between the stage coordinate system and the coordinate system of the image capturing unit 103 and the projection unit 102 is determined using the external parameters included in the calibration data independent of the Z position. In addition, the internal parameters included in the calibration data independent of the Z position are used as the calculation initial values in the nonlinear optimization method, thereby calculating the calibration data for each Z position described above.

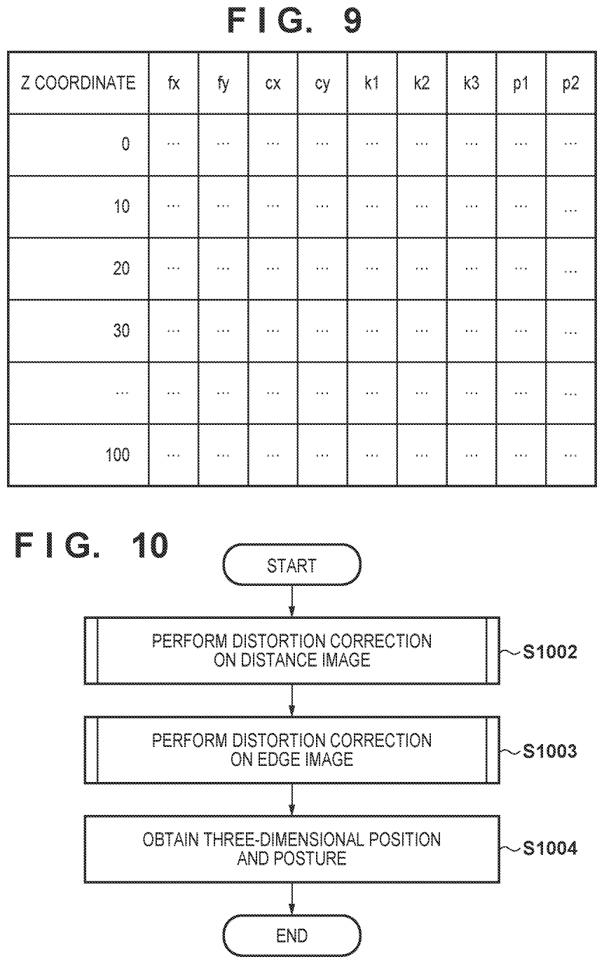

The calibration data for each Z position can be generated as table data by associating the Z position with the corresponding calibration data for each Z position (Z-coordinate), as shown in FIG. 9. In FIG. 9, the calibration data (fx, fy, cx, cy, k1, k2, k3, p1, and p2) corresponding to the Z positions (Z-coordinates)=0, 10, 20, . . . , 100 are registered. In addition, a polynomial D=f(z) for approximating calibration data for each Z position may be obtained as the calibration data for each Z position. This polynomial D=f(z) is a function for defining the relationship between the Z position and the calibration data. This function outputs calibration data D corresponding to z using the Z position=z as the argument.

The processing of each of steps S403 and S404 described above can be performed by the image processing apparatus 121 or any apparatus except the image processing apparatus 121. Even if the processing in each of steps S403 and S404 is executed by any apparatus, the calibration data generated above can be appropriately input to the image processing apparatus 121 as the calibration data 125. Note that the method of generating the calibration data 125 is not limited to the above method.

In step S501, distortion correction is performed for the first captured image using the calibration data independent of the Z position out of the calibration data 125 generated as described above. By using the distortion-corrected first captured image, the first distance image is generated based on the principle of triangulation. Since the first distance image is calculated based on the first distance image independent of the Z direction, the first distance image has poor quality because an influence of different distortions at Z positions caused by coma is not considered. Therefore, this influence is corrected in the following processing step.

Next, in step S502, an image distortion correction unit 122 selects, as a selected pixel, an unselected pixel in the first captured image distortion-corrected in step S501. The selection order of the pixels in the first captured image distortion-corrected in step S501 is not limited to a specific selection order. For example, pixels can be selected in the raster scan order.

In step S503, if the pixel position of the selected pixel in the first captured image distortion-corrected in step S501 is defined as (xs, ys), the image distortion correction unit 122 specifies the pixel value, that is, a distance value d at the pixel position (xs, ys) in the first distance image.

In step S504, based on the “calibration data for each Z position” generated in accordance with the flowchart in FIG. 4, the image distortion correction unit 122 acquires the Z-position calibration data corresponding to the distance value d specified in step S503.

If the “calibration data for each Z position” is managed as the table data shown in FIG. 9, the Z-position calibration data corresponding to the distance value d can be obtained from this table data. If no Z-position calibration data corresponding to the distance value d is not registered, Z-position calibration data closest to the distance value d may be acquired from the table data. Alternatively, if the Z-position calibration data corresponding to the distance value d is not registered in the table data, calibration data interpolated from the calibration data corresponding to a plurality of Z positions near the distance value d may be acquired as the calibration data corresponding to the distance value d.

If the “calibration data for each Z position” is managed as the above polynomial D=f(z), the output from f(d) can be acquired as the calibration data corresponding to the distance value d.

By using the calibration data corresponding to the distance value d, the image distortion correction unit 122 performs distortion correction processing for the selected pixel in the first captured image distortion-corrected in step S501. For example, by distortion correction using the calibration data corresponding to the distance value d, the image distortion correction unit 122 determines a specific pixel position to which the pixel position of the selected pixel is converted. The image distortion correction unit 122 then moves the selected pixel to the obtained pixel position.

The image distortion correction unit 122 determines in step S505 whether all the pixels of the first captured image distortion-corrected in step S501 have been selected as the selected pixels. If the image distortion correction unit 122 determines that all the pixels of the first captured image distortion-corrected in step S501 have been selected as the selected pixels, the process advances to step S506. On the other hand, if the image distortion correction unit 122 determines that an unselected pixel is left in the first captured image distortion-corrected in step S501, the process returns to step S502.

Note that the processing in steps S502 to S504 is performed for all the pixels in the first captured image in FIG. 5, but the present invention is not limited to this. For example, pixels used to calculate the first distance point may be distortion-corrected again, and the remaining pixels may be interpolated.

In step S506, the image distortion correction unit 122 generates a distance image (the second distance image) based on the first captured image distortion-corrected in step S504. A distance image generation method is similar to that in step S501. The process advances to step S1003 in FIG. 10.

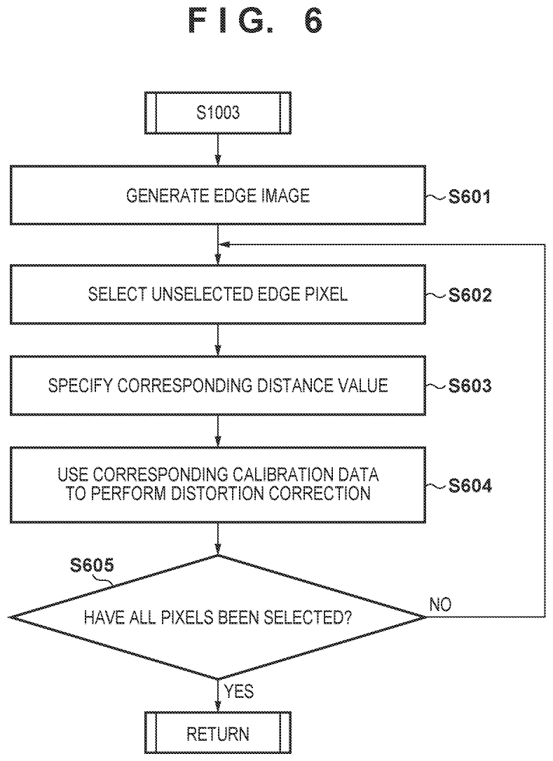

Referring back to FIG. 10, in step S1003, the image processing apparatus 121 performs distortion correction processing for an edge image based on the second captured image. Details of the processing in step S1003 will be described with reference to the flowchart in FIG. 6.

In step S601, an edge image generation unit 126 performs distortion correction processing for the second pictured image using the calibration data independent of the Z position and generates an edge image (the image having edge information such as the contour and ridge of the object 100) of the distortion-corrected second captured image.

In step S602, a corresponding pixel specifying unit 127 selects, as a selected edge pixel, an unselected edge pixel of the pixels (edge pixels) forming an edge of the edge image. Note that in step S602, not only an edge pixel but also a non-edge pixel may be selected.

In step S603, the corresponding pixel specifying unit 127 specifies a pixel position P on the first captured image corresponding to the selected edge image (the first captured image distortion-corrected in step S501). Ideally, the image captured by the image capturing element 202 and the image captured by the image capturing element 203 do not have a parallax. However, in practice, a parallax occurs due to an installation error in assembly. A pixel shift of about several pixels occurs between the image captured by the image capturing element 202 and the image captured by the image capturing element 203.

For this reason, a two-dimensional projection transformation matrix for implementing the two-dimensional projection transformation between the image captured by the image capturing element 202 and the image captured by the image capturing element 203 is required. By using this two-dimensional projection transformation matrix, the pixel position (x′, y′) on the image captured by the image capturing element 202 and corresponding to the pixel position (x, y) on the image captured by the image capturing element 203 can be specified. The two-dimensional projection transformation matrix is obtained in advance and is input to the image processing apparatus 121 as needed.

An example of a method of obtaining a two-dimensional projection transformation matrix will be described below. The calibration board is placed on the uniaxial moving stage, and the image capturing element 202 and the image capturing element 203 capture the uniaxial moving stage (the calibration board) while the uniaxial moving state is fixed at an arbitrary Z position within the measurable range on the Z-axis. At this time, the projection pattern is not projected. The two-dimensional coordinates, on the image captured by the image capturing element 202, of the feature point of each index on the calibration board are defined as ml, and the two-dimensional coordinates, on the image captured by the image capturing element 203, of the feature point of each index on the calibration board are defined as m2. At this time, a two-dimensional projection transformation matrix H which satisfies equation (9) for the feature points of all indices within the fields of view of the image capturing element 202 and the image capturing element 203 exists.

m₁=Hm₂ (9)

In this case, the two-dimensional projection transformation matrix H is a 3×3 matrix, and its degree of freedom is 8. The calculation can be made by combinations of the two-dimensional coordinates m1 and m2 of four or more points on the same plane. In this case, the two-dimensional coordinates m1 and m2 of the indices must be the two-dimensional coordinates on the distortion-corrected image. The calibration data independent of the Z position can be used as the calibration data used to correct the image distortion. However, the calibration data corresponding to the Z position at which the calibration board is captured can be calculated in advance, and the image distortion is corrected using this calibration data, thereby generating a high-accuracy two-dimensional projection transformation matrix.

The pixel position obtained by transforming the pixel position of the selected edge pixel on the edge image can be obtained as the pixel position P on the first captured image corresponding to the pixel position of the selected edge pixel on the edge image by using the two-dimensional projection transformation matrix H obtained as described above. Note that if the pixel position P on the first captured image corresponding to the pixel position of the selected edge pixel on the edge image can be specified, its specifying method is not limited to a specific one. The corresponding pixel specifying unit 127 acquires the pixel value, that is, the distance value, at the pixel position P in the first distance image (or the second distance image).

Note that since the position of the selected edge pixel is subpixel-estimated, there may be no corresponding pixel position in the distance image (the first distance image/the second distance image). This also applies to a case in which the coordinate value of the pixel position obtained by transforming the pixel position of the selected edge pixel on the edge image by using the two-dimensional projection transformation matrix H is not an integer. In this case, an interpolation using, for example, a known interpolation method such as a nearest neighbor method or a bilinear method can be performed based on the distance value of neighboring pixels.

In step S604, the image distortion correction unit 122 performs distortion correction processing for the selected edge pixel by using the calibration data corresponding to the distance value acquired in step S603. The distortion correction in step S604 is similar to that in step S504 described above.

The image distortion correction unit 122 determines in step S605 whether all the edge pixels of the edge image are selected as the selected edge pixels. If the image distortion correction unit 122 determines that all the edge pixels of the edge image are selected as the selected edge pixels, the process advances to step S1004. On the other hand, if the image distortion correction unit 122 determines that an unselected edge pixel is left in the edge image, the process returns to step S602. The distortion correction in step S604 is performed for all the edge pixels of the edge image, thereby performing distortion correction of the edge image.

In step S1004, a calculation unit 124 obtains the three-dimensional position and posture of the object 100 by performing model fitting with the model data (for example, CAD data) of the object 100 based on the second distance image and the edge image distortion-corrected in step S1003. The three-dimensional position and posture of the object 100 calculated by the calculation unit 124 may be stored in a memory in the image processing apparatus 121, an external memory connected to the image processing apparatus 121, a server apparatus, or the like, or may be displayed on a monitor (not shown).

### Second Embodiment

Each embodiment including this embodiment will mainly describe a difference from the first embodiment. Unless otherwise specified, the following embodiments are similar to the first embodiment. The information for specifying a pixel position (x′, y′) on an image captured by an image capturing element 202 which corresponds to a pixel position (x, y) on an image captured by an image capturing element 203 is not limited to a two-dimensional projection transformation matrix. For example, information acquired by the following method can be used in place of the two-dimensional projection transformation matrix.

First, an object (for example, a calibration board) having a feature amount serving as an evaluation reference is placed on the uniaxial moving stage. The image capturing element 202 and the image capturing element 203 capture the uniaxial moving stage (the calibration board) while the uniaxial moving state is fixed at an arbitrary Z position within the measurable range on the Z-axis. At this time, the projection pattern is not projected. The distortions of the image captured by the image capturing element 202 and the image captured by the image capturing element 203 are corrected as described above. A positional shift amount between the portions where the image feature amounts of the image captured by the image capturing element 202 and the image captured by the image capturing element 203 are similar to each other is obtained. The obtained positional shift amount is used in place of the two-dimensional projection transformation matrix. That is, by adding this positional shift amount to the coordinates on the image captured by the image capturing element 203, the coordinates corresponding to the image captured by the image capturing element 202 can be obtained.

### Third Embodiment

In the first and second embodiments, the distance image is generated from the captured image of the object 100 on which the projection pattern is projected. The distance image may be generated using another method. For example, a distance image may be generated by another method such as a Time of Flight.

### Fourth Embodiment

Processing according to the flowchart of FIG. 5 may be modified as follows. In step S502, an image distortion correction unit 122 selects, as a selected pixel, an unselected pixel in the first distance image. In step S503, the image distortion correction unit 122 specifies the pixel value, that is, a distance value d of the selected image in the first distance image. In step S504, based on the “calibration data for each Z position” generated in accordance with the flowchart in FIG. 4, the image distortion correction unit 122 acquires the Z-position calibration data corresponding to a distance value d specified in step S503. The image distortion correction unit 122 performs the distortion correction processing for the selected pixel in the first distance image by using the calibration data corresponding to the distance value d. In step S505, the image distortion correction unit 122 determines whether all the pixels of the first distance image are selected as the selected pixels. If the image distortion correction unit 122 determines that all the pixels of the first distance image are selected as the selected pixels, the process advances to step S1003. On the other hand, if the image distortion correction unit 122 determines that an unselected pixel is left in the first distance image, the process returns to step S502. Step S506 is unnecessary. With the above processing, the distortion-corrected first distance image can be generated as the second distance image.

In this case, in the processing according to the flowchart of FIG. 6, in step S603, the pixel position on the first distance image which corresponds to the selected edge pixel is specified using the correspondence relationship between the pixels of the second capture image and the distortion-corrected first distance image.

### Fifth Embodiment

The respective function units (excluding calibration data 125) in an image processing apparatus 121 shown in FIG. 1 are implemented by hardware, but may be implemented by software. In the latter case, a computer apparatus capable of executing such software can be applied to the image processing apparatus 121. The hardware arrangement example of the computer apparatus applicable to the image processing apparatus 121 will be described with reference to the block diagram in FIG. 8.

A CPU 801 executes processing using computer programs and data stored in a main memory 802. Accordingly, the CPU 801 controls the entire operation of the computer apparatus and executes or controls the respective processes as processes performed by the image processing apparatus 121. A GPU 810 performs various kinds of image processing using various kinds of images such as a captured image, a distance image, and an edge image.

The main memory 802 includes a work area used to execute various kinds of processing of the CPU 801 and the GPU 810 and an area for storing the computer programs and data loaded from a storage unit 803 and a ROM 804. In this manner, the main memory 802 can provide various kinds of areas as needed.

The storage unit 803 is a large-capacity storage device represented by a hard disk drive and a solid stage drive (SSD). The storage unit 803 stores an OS (Operating System) and computer programs and data for causing the CPU 801 and the GPU 810 to execute or control the various kinds of processing as the processing to be executed by the image processing apparatus 121. The computer programs stored in the storage unit 803 include computer programs for causing the CPU 801 and the GPU 810 to execute or control each processing described above as the processing performed by the functional units of the image processing apparatus 121 shown in FIG. 1. The data stored in the storage unit 803 include information described as known information in the above description, such as the calibration data, and the two-dimensional projection transformation matrix data. The computer programs and data stored in the storage unit 803 are loaded to the main memory 802 as needed in accordance with control by the CPU 801 and serve as processing targets by the CPU 801 and the GPU 810. The ROM 804 stores computer programs and data pertaining to the BIOS of the computer apparatus.

A display device 808 is connected to a video card 806. The display device 808 is formed from a CRT or a liquid crystal screen and can display the processing results of the CPU 801 and the GPU 810 in the forms of images and/or characters. Note that the display device 808 can be a touch panel screen.

An input device 809 is connected to a general I/F (interface) 807 such as a USB (Universal Serial Bus). The input device 809 is formed from a user interface such as a mouse and a keyboard. When operated by the user, the display device 808 can input various kinds of instructions to the CPU 801. Note that the three-dimensional scanner 101 may be connected to this general I/F 807. The CPU 801, the GPU 810, the main memory 802, the storage unit 803, the ROM 804, the video card 806, and the general I/F 807 are connected to a system bus 805.

### Sixth Embodiment

The system shown in FIG. 1 can be used as a measuring apparatus 1100 in a state in which it is supported by a certain support member. According to this embodiment, as an example, a control system used in such a manner that a robot arm (gripping device) 1300 is provided with the system, as shown in FIG. 11, will be described below. The measuring apparatus 1100 projects pattern light onto a target object 1210 placed on a support table 1350 to capture the target object, thereby acquiring the image of the target object. The control unit of the measuring apparatus 1100 or a control unit 1310 which has acquired the image data from the control unit of the measuring apparatus 1100 obtains the position and posture of the target object 1210. The control unit 1310 acquires the information of the obtained position and posture. Based on this information of the position and posture, the control unit 1310 sends a driving command to the robot arm 1300 to control the robot arm 1300. The robot arm 1300 holds the target object 1210 with a robot hand (gripping portion) at the distal end of the robot arm 1300 and performs movement such as translation and rotation. At this time, as described in the above embodiments, by accurately grasping the edge image of the target object 1210 (a work, an assembly part, or an object to be processed), the robot arm 1300 can accurately holds and moves the target object 1210. In addition, by attaching the target object 1210 to another part by the robot arm 1300, an article formed from a plurality of parts, such as an electronic circuit board or a machine, can be manufactured. In addition, by processing the moved target object 1210, an article can be manufactured. The control unit 1310 includes an arithmetic device such as a CPU and a storage device such as a memory. Note that the control unit for controlling the robot may be arranged outside the control unit 1310. In addition, the measurement data (measurement results) obtained by the measuring apparatus 1100 and the resultant images may be displayed on a display unit 1320 such as a display. Note that the some or all of the embodiments described above can be used in combinations as needed.

### Other Embodiments

According to the arrangement of the present invention, the three-dimensional position and posture of the object can be measured at high speed and high accuracy by using the distance image and the edge image of the object.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising:
an acquisition unit configured to acquire a first image obtained by capturing an image of an object on which pattern light is projected and a second image obtained by capturing an image of the object on which light not containing the pattern light is projected;
a first correction unit configured to generate a first distance image having a distance value for each pixel based on the first image and correct distortion of the first image based on the distance value of the first distance image;
a generation unit configured to generate a second distance image having a distance value for each pixel based on the first image obtained after correcting distortion of the first image by the first correction unit; and
a second correction unit configured to correct distortion of an edge image having edge information of the object in the second image by using the distance value of a corresponding pixel in the first distance image or the second distance image for each pixel of the edge image.

2. The image processing apparatus according to claim 1, wherein the second correction unit specifies a pixel of the first image corresponding to each pixel of the edge image based on a correspondence relationship between the pixel of the first image and the pixel of the second image, and performs correction corresponding to a distance value of a corresponding pixel of the first distance image which corresponds to the specified pixel.

3. The image processing apparatus according to claim 2, wherein the correspondence relationship is defined by a two-dimensional projection transformation matrix between the first image and the second image.

4. The image processing apparatus according to claim 1, wherein the first correction unit performs different correction depending on a distance value of a corresponding pixel of the first distance image for each pixel of the first image by using the distance value.

5. The image processing apparatus according to claim 2, wherein the second correction unit specifies a correction parameter corresponding to a distance value of the corresponding pixel from correction parameters obtained in advance for a plurality of distance values and corrects distortion of the edge image using the specified correction parameter.

6. The image processing apparatus according to claim 2, wherein the second correction unit specifies a correction parameter corresponding to the distance value of the corresponding pixel by using a function which defines a relationship between a distance value and a correction parameter and corrects distortion of the edge image by using the specified correction parameter.

7. The image processing apparatus according to claim 1, comprising a unit configured to obtain a three-dimensional position and posture of the object based on the edge image distortion-corrected by the second correction unit and the second distance image.

8. An image processing apparatus comprising:
an acquisition unit configured to acquire a first image obtained by capturing an image of an object on which pattern light is projected and a second image obtained by capturing an image of the object on which light not containing the pattern light is projected;
a first correction unit configured to generate a distance image having a distance value for each pixel based on the first image and correct distortion of the distance image based on the distance value of the distance image; and
a second correction unit configured to correct distortion of an edge image having edge information of the object in the second image by using the distance value of a corresponding pixel in the distance image corrected by the first correction unit for each pixel of the edge image.

9. The image processing apparatus according to claim 8, further comprising a unit configured to obtain a three-dimensional position and posture of the object on which the pattern light is projected, based on the edge image distortion-corrected by the second correction unit and the distance image distortion-corrected by the first correction unit.

10. The image processing apparatus according to claim 1, wherein light entering from the object on which the pattern light and uniform illumination light are projected is separated into light beams having different wavelengths, and the pattern light and the uniform illumination light of the separated light beams enter an image capturing device configured to capture the first image and an image capturing device configured to capture the second image, respectively.

11. A system comprising:
an image processing apparatus including;
an acquisition unit configured to acquire a first image obtained by capturing an image of an object on which pattern light is projected and a second image obtained by capturing an image of the object on which light not containing the pattern light is projected;
a first correction unit configured to generate a first distance image having a distance value for each pixel based on the first image and correct distortion of the first image based on the distance value of the first distance image;
a generation unit configured to generate a second distance image having a distance value for each pixel based on the first image obtained after correcting distortion of the first image by the first correction unit; and
a second correction unit configured to correct distortion of an edge image by using the distance value of a corresponding pixel in the first distance image or the second distance image for each pixel of the edge image having edge information of the object in the second image; and
a robot configured to hold and move the object based on an image processed by the image processing apparatus.

12. A method of manufacturing an article, comprising:
acquiring a first image obtained by capturing an image of an object on which pattern light is projected and a second image obtained by capturing an image of the object on which light not containing the pattern light is projected;
generating a distance image having a distance value for each pixel based on the first image and correcting distortion of the distance image based on the distance value of the distance image;
correcting distortion of an edge image having edge information of the object in the second image by using the distance value of a corresponding pixel in the distance image corrected for each pixel of the edge image; and
holding and moving the object based on the edge image distortion-corrected.

13. An image processing method comprising:
acquiring a first image obtained by capturing an image of an object on which pattern light is projected and a second image obtained by capturing an image of the object on which light not containing the pattern light is projected;
generating a first distance image having a distance value for each pixel based on the first image and correcting distortion of the first image based on the distance value of the first distance image;
generating a second distance image having a distance value for each pixel based on the first image obtained after correcting distortion of the first image; and
correcting distortion of an edge image having edge information of the object in the second image by using the distance value of a corresponding pixel in the first distance image or the second distance image for each pixel of the edge image.

14. An image processing method comprising:
acquiring a first image obtained by capturing an image of an object on which pattern light is projected and a second image obtained by capturing an image of the object on which light not containing the pattern light is projected;
generating a distance image having a distance value for each pixel based on the first image and correcting distortion of the distance image based on the distance value of the distance image; and
correcting distortion of an edge image having edge information of the object in the second image by using the distance value of a corresponding pixel in the distance image corrected for each pixel of the edge image.

15. A non-transitory computer-readable storage medium storing a program for causing a computer to function as:
an acquisition unit configured to acquire a first image obtained by capturing an image of an object on which pattern light is projected and a second image obtained by capturing an image of the object on which light not containing the pattern light is projected;
a first correction unit configured to generate a first distance image having a distance value for each pixel based on the first image and correct distortion of the first image based on the distance value of the first distance image;
a generation unit configured to generate a second distance image having a distance value for each pixel based on the first image obtained after correcting distortion of the first image by the first correction unit; and
a second correction unit configured to correct distortion of an edge image having edge information of the object in the second image by using the distance value of a corresponding pixel in the first distance image or the second distance image for each pixel of the edge image.
